(19) United States
(12) Patent Application Publication
(10) Pub. No.: US 2011/0041348 A1
(43) Pub. Date: Feb. 24, 2011

(54) MUDDLER

(75) Inventors: Michael Henry Silvers, Ultimo (AU); Sam Tam, Ultimo (AU)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: HOWARD SILVERS & SONS PTY LTD, Ultimo (AU)

(21) Appl. No.: 12/545,806

(22) Filed: Aug. 21, 2009

(51) Int. Cl. B26B 27/00; A47J 43/04

(52) U.S. Cl. 30/276; 241/169.1

(57) ABSTRACT

A muddler comprises an elongated member that ends in a head with spikes for crushing fruit pieces or other flavor ingredients. The head can be removed and, in a reverse mode, the muddler can be used as an ice crusher. Optional side located stirring ribs or formations may be provided to facilitate stirring. There can be a finger grip portion at the top to facilitate handling and muddling action.

### RELATED APPLICATION

This application relates to U.S. Design patent application Ser. No. ______, filed ______, 2009, the contents of which are incorporated by reference herein in its entirety.

### BACKGROUND

The disclosure pertains to a muddler and stirrer.

A muddler is a bar tool that can be used to extract flavors from beverage ingredients such as citrus fruit pieces, by braking them up or crushing them. A paddle-type stirrer is good for this purpose but a beverage. The muddler is effective for extracting flavor from fruit and for dispersing fruit pieces into a beverage, but does not serve particularly well as a stirrer and there is a need to render the muddler more versatile, than simply being an extraction device.

### SUMMARY

The disclosure provides a muddler which operates more efficiently and also provides different functions. The device has the attributes of both a muddler and an ice crusher.

### DRAWINGS

The above-mentioned features of the present disclosure will become more apparent with reference to the following description taken in conjunction with the accompanying drawings wherein like reference numerals denote like elements and in which:

FIG. 1 is a first side view of the muddler of the present disclosure, illustrating the processing of fruit slices in a glass;

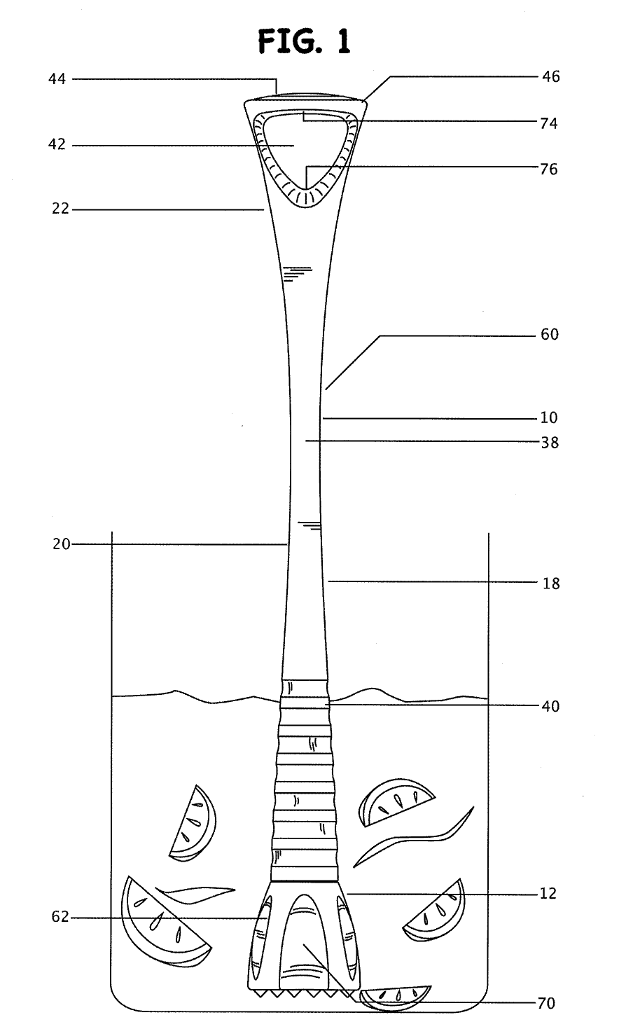

FIG. 2 is FIG. 1 is a second side view of the muddler of the present disclosure, the view being a 90 degree turn relative to FIG. 1;

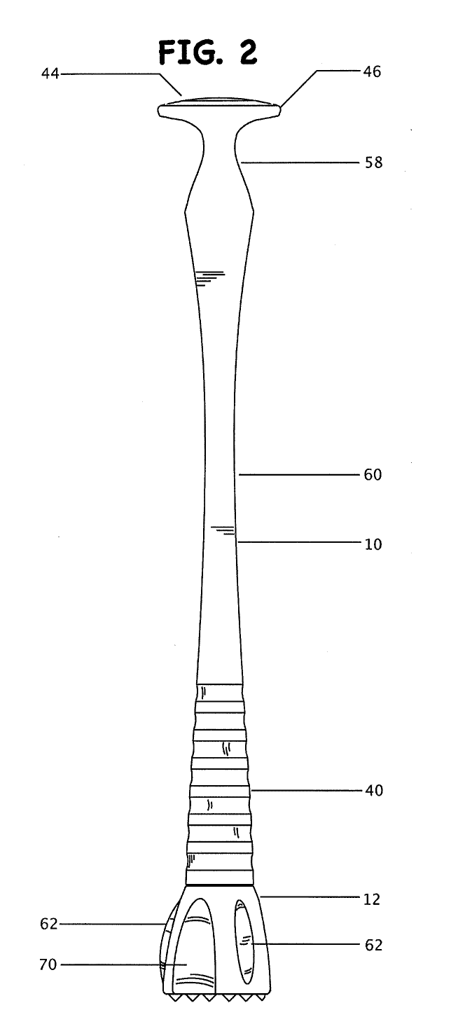

FIG. 3 is top view of the muddler;

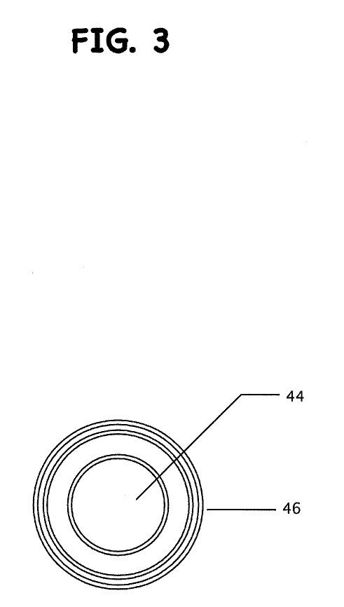

FIG. 4 is a second use of the muddler as an ice crusher, the perspective view being from the top of the muddler as inserted in a glass;

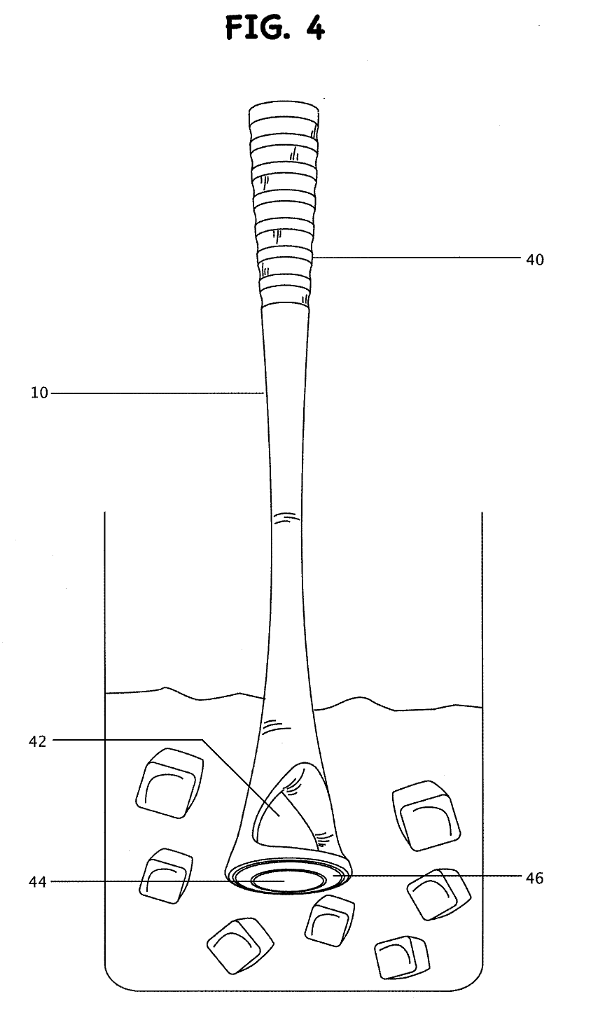

FIG. 5 is a perspective view from the bottom of the muddler;

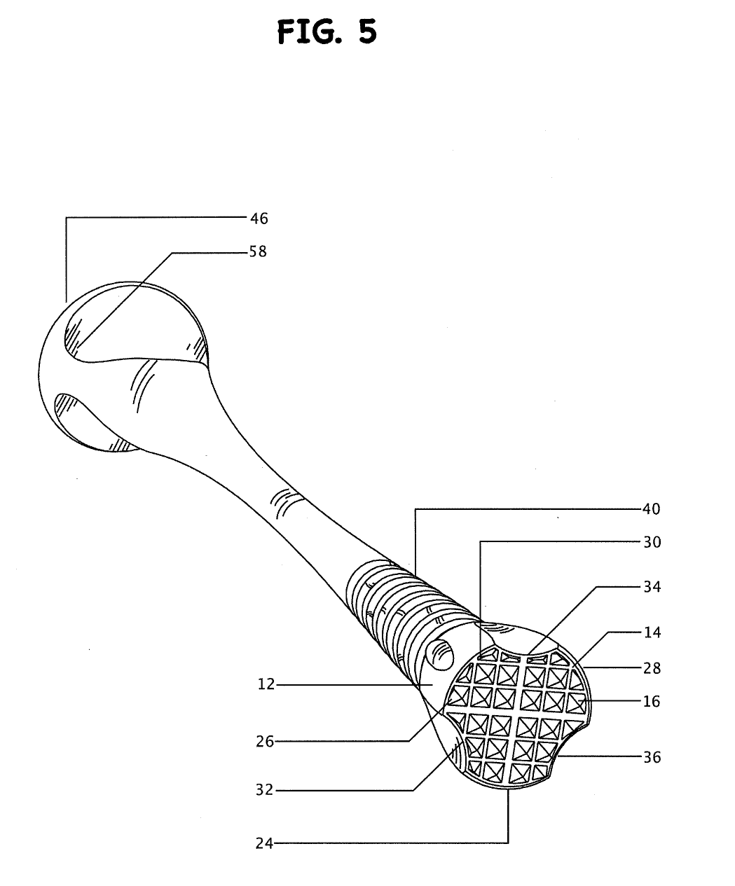

FIG. 6 is a \perspective view from the top of the muddler with parts separated;

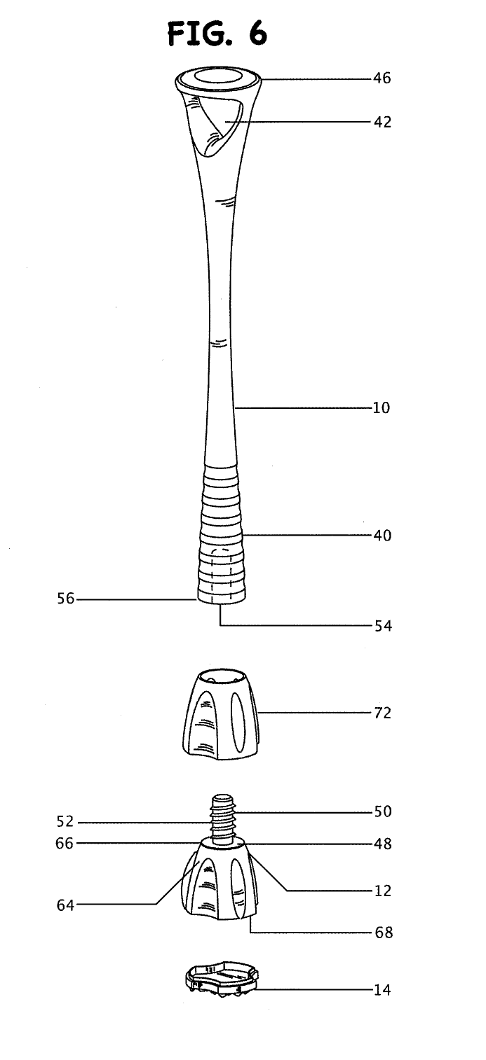

FIG. 7 is a view from the bottom of the muddler.

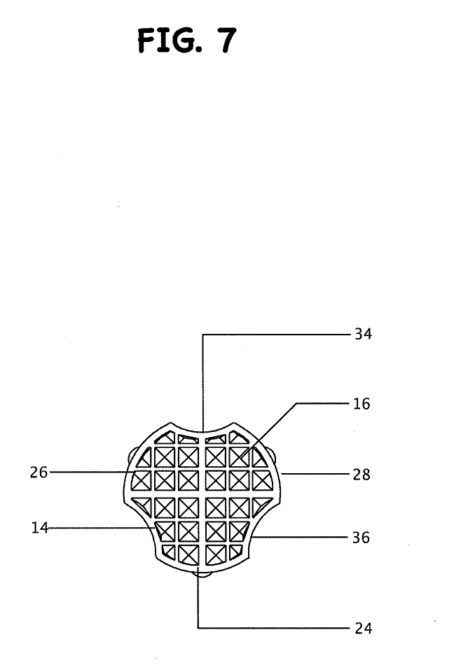

### DETAILED DESCRIPTION

A combination muddler and ice crusher comprises an elongated member terminating in a head; and at a location towards a top of the muddler. The muddler action is with the head operational downwardly, and the ice crusher action being in reverse when the top is located downwardly. Towards the top there is an aperture or formation to facilitate accommodating a finger or thumb of a user. This permit enhanced action of the muddler. The top area is an ice crusher when the top is located in engagement with ice.

There is provided an elongated element elongated member 10 that terminates in a screw connected and removable head 12. The head 12 has a lower surface 14 from which extends a plurality of projections 16, which extend from the surface 14 of the head 12, namely at the bottom of the elongated member 10. The projections 16 are spikes, and they are arranged in a particular pattern on the bottom surface 14.

The elongated member 10 has an exterior concave type surface that is, in part, relatively flatter at 20 and in other part relatively more curved at 22, and ends at a handle at the top which is relatively outwardly flared compared to the narrower portion of the shaft 10.

A device comprises a elongated member 10 that is adapted to act as a muddler and an ice crusher. The head 12 has three lobes 24, 26 and 28 arranged equilaterally around the longitudinal axis of the elongated member 10. The outside perimeter 30 of the lobes 24, 26, and 28 is such that there are outwardly curved portions 24, 26 and 28 and between those portions inwardly ducted portions 32, 34, and 36. There can be any number of shapes for the head perimeter 30.

The central axis 38 of the elongated member 10 passes through the head 12 substantially at right angles to the surface 14. The surface 14 of the head 12 has projections 16 that extend from it. These projections 16 are small spikes that can assist with breaking apart a fruit such as a slice of citrus fruit commonly found in beverages such as cocktails. The number of projections or spikes 16 from the surface 14 can vary according to the desired use of the muddler. In some circumstances there can be many more than shown in the drawings. The drawings are only illustrative, and the size and shape of the projections can vary. The surface 14 is provided in some circumstances as part of a removable plate element 114, which has peripheral grooves, lips or the like to so the plate 114 can removable fit on the base of the head 12.

The device 10 can be long enough to extend past the rim of a drinking glass when the head 12 is resting on the bottom of the glass. The surface area of the head 12 is designed such that reciprocating the device vertically and/or transversely or a combination of movements creates a stirring or mixing effect in the glass.

This stirring effect can be enhanced by providing the device 10 with stirring ribs 40. The stirring ribs 40 may be one or more in number and can be evenly spaced around the circumference of the elongated member 10. The ribs 40 extend between the head 12 and at least a lower portion 18 of the elongated member 10. As such, the rotary stirring action of the device is enhanced, and can be turned between the fingers and not just reciprocated vertically.

There is an aperture 42 in the top of the elongated member 10 for locating a finger or thumb. The action the muddler by hand action can be enhanced and more positively transmitted to the muddler through this ability to grip the muddler more positively. The shape of the muddler shaft 10 also facilitates the positive action. At the top face 44 of the shaft there is an indentation 46 for locating the ball of the thumb.

The top end 48 of the head 12 is screw connected with the elongated member 10. The end 48 of the head 12 has a central shaft 50 with screw threads 52 to connect with an internal bore 54 at the end 56 of the elongated shaft 10 and along the axis 38. Different forms of connection are possible as an alternative to the screw connection.

The underside surface 14 of the head 12 shows an arrangement of spikes or projections 16. It is understood that this particular pattern represents only an example and not a limiting feature of the disclosure. The external spike surface 16 of the elongated member 10 may be polyhedral, in this example, relatively on a square base.

The elongated member 10 varies in cross section from the upper surface of the head 12 to a location adjacent to the upper end 44 of the device. The upper end 44 of the elongated member 10 is round in cross section and has a central indentation 46. Below the circular top surface 44, the elongated member 10 has an undercut waist 58 when considered from one side view where the aperture 42 is formed for the finger. When considered, viewed around its axis 38, the side wall surface 60 of the elongated member 10 gradually curves inwardly between the areas 20 and 22 so that the narrowest part of the overall shaft is about midway along the overall length of the elongated member 10. The waist 58 where the finger grip is at the top of the muddler may be narrower, when viewed or considered from one side view

There are a series of outwardly extending extraction ribs or lobes 62 which are relatively elliptically formed and circumferentially spaced ribs that extend on the outer surface 64 of the head 12 almost to the top edge 66 of the head 12 and also to the lower surface interface at 68. The ribs 62 also presents an undulated perimeter to allow for fruit to move to either side of the head 12. These ribs 62 allow juice and oils of the fruit to be extracted on the side of the muddler head 12. This is in addition to the muddling occurring with the surface 14.

Along the side wall surface 64 of the head 12 there are circumferentially spaced indented formations, lobes or ribs 70 positioned on the surface 64. These formations or ribs 70 are indentations alternating circumferentially with the protrusion ribs 62 on the outer surface 64 of the head 12. The concave elliptical cuts outs 70 assist in eliminating suctions and drag when the fruit is being crushed and muddled. Different amounts of the side formations or ribs 70 and ribs 62 can be provided.

When the head 12 is removed, and the muddler 10 is turned upside down, the portion 44 that is normally the area for locating the thumb is used for breaking or crushing ice. The outside surface on the shaft being the elongated member 10, with the spaced transverse ribs 40 facilitates non-slip handling by the hand or fingers when the device is used for ice crushing.

In some cases there can be a cover member or shawl 72 for the head 12.

While the present disclosure has been disclosed with reference to particular details of construction, these should be understood as having been provided by way of example and not as limitations to the scope or spirit of the disclosure. In particular, the precise cross sectional shape of the elongated member 10 can be varied. The external configuration may be determined by any number of factors both aesthetic and functional. The centrally narrower or thinner art of the shaft 10 facilitates the operation of the muddler. The shape of the aperture 42 towards the top of the shaft 10 for accommodating a finger can be varied. As shown the shape is essentially triangular, with the flat 74 of the essentially triangular opening being adjacent the top 44 of the device 10 and the to other sides tapering to an apex 76 at a location removed from the top 44.

It will be understood that the shape of the exterior of the elongated member 10 may be regular, smooth or irregular in cross section, square, or otherwise curved or straight. Elongated shapes of this kind are easier to twirl than flat or paddle shapes.

It will also be understood that the size, shape, number and even presence of extending projections on the underside of the head represent design choices over which there is a wide range of latitude. There can be various modifications and similar arrangements included within the spirit and scope of the claims, the scope of which should be accorded the broadest interpretation so as to encompass all such modifications and similar structures. The present disclosure includes any and all embodiments of the following claims.

1. A muddler comprising: an elongated member terminating in a head; and at a location towards a top of the muddler there is an aperture or formation to facilitate accommodating a finger or thumb of a user and thereby permit enhanced action of the muddler.

2. The device of claim 1 wherein an underside of the head has a plurality of projections, the projections selectively being spikes.

3. The device of claim 1 wherein on the top of the muddler there being an indentation to facilitate accommodating a thumb of a user and thereby permit enhanced action of the muddler.

4. The device of claim 1 comprising one or more stirring ribs or formations extending between a lower portion of the head and being located upwardly in the direction of the elongated member, the stirring ribs being selectively circular formations about the shaft.

5. The device of claim 1 including a surface of the head extending from a base of the head towards the shaft, the surface including an outer periphery of the head having an undulating shape.

6. The device of claim 1 wherein the head includes a lower surface, the perimeter of the lower surface having a transverse cross section essentially of multiple spaced lobes.

7. The device of claim 4 wherein the stirring ribs or formations are evenly spaced around a circumference of a head.

8. The device of claim 1 wherein the head is removably mountable on a shaft forming the elongated member, the head being selectively screw mounted on an end of the of the elongated shaft.

9. The device of claim 1 wherein an outer surface of the elongated member is in part round about portion of the length of the shaft, and in other part has an undercut irregular cross section.

10. The device of claim 1 wherein at least a portion of an outer surface of the elongated member includes is an inwardly curved or concave elongated portion, and the elongated member has a regular cross section over of the greater part of its length.

11. The device of claim 9 wherein the undercut accommodates an aperture, selectively essentially triangular in shape.

12. The device of claim 1 wherein the elongated member has transverse ribs, the ribs being located at least in the area of the head, and wherein with the elongated member in reverse position, namely with the normally head locating portion upwards, the ribs facilitate gripping and the top of the elongated member is usable as an ice crusher.

13. The device of claim 2 wherein the projections are polyhedral portions of the head member, and the portions are square in cross section.

14. A combination muddler and ice crusher comprising: an elongated member terminating in a head; and at a location towards a top of the muddler, the muddler action being with the head is operational downwardly, and the ice crusher action being when the top is located downwardly.

15. The device of claim 14 wherein towards the top there is an aperture or formation to facilitate accommodating a finger or thumb of a user and thereby permit enhanced action of the muddler, and the top area being an ice crusher when the top is located in engagement with ice.
